(19) United States
(12) Patent Application Publication
(10) Pub. No.: US 2020/0163825 A1
(43) Pub. Date: May 28, 2020

(54) ORIENTATION, LOCATION AND PRESSURE SENSITIVE SEXUAL STIMULATION DEVICE

(71) Applicant: Thika Holdings LLC, St. Pete Beach, FL (US)

(72) Inventor: Vivien Johan Cambridge, Myrtle Beach, SC (US)

(73) Assignee: Thika Holdings LLC, St. Pete Beach, FL (US)

(21) Appl. No.: 16/694,622

(22) Filed: Nov. 25, 2019

Related U.S. Application Data
(60) Provisional application No. 62/771,048, filed on Nov. 24, 2018.

(51) Int. Cl. A61H 19/00; A61H 23/02

(52) U.S. Cl. CPC A61H 19/00; A61H 2201/5007; A61H 2201/5071; A61H 23/02

(57) ABSTRACT

A vibrating masturbation device is disclosed herein. The device generally includes a vibrational motor and a sensor. The sensor detects physical manipulation (i.e. movement, tilting, rotation, etc.) of the device, and the vibrational motor is dynamically adjusted based on the physical manipulation of the device.

### INCORPORATION BY REFERENCE

This application claims the benefit of U.S. Provisional Application No. 62/771,048, filed Nov. 24, 2018, which is incorporated by reference as if fully set forth.

### FIELD OF INVENTION

This invention relates to vibrating sexual stimulation or masturbation devices. Specifically, the invention relates to vibrating sexual stimulation devices including the capability to vary vibrational profiles or characteristics.

### BACKGROUND OF THE INVENTION

There is a robust adult toy industry including vibrational devices that are designed to stimulate a user's genitals. One type of masturbation device includes a phallic shaped toy that can vibrate and is designed to contact regions of a user's genitals that are both external and internal.

Known masturbation devices allow users to adjust multiple regarding the vibration, including intensity of the vibrations, as well as the ability to vibrate according to any number of patterns. Typically, a button, knob, or other control element is provided on the body of the device, Other variations of masturbation devices allow some degree of remote control to drive the vibrations of the device.

Users can manipulate dials, knobs, buttons, or control elements throughout usage of the masturbation device. However, known devices require users to manually adjust settings through usage of the masturbation device, which can be distracting. In addition, slight variations of vibration through manipulation of the position and orientation of the masturbation device can enhance the sensuality, intuitiveness and effectiveness of the masturbation process.

It would be desirable to provide a masturbation device that does not require ongoing manual adjustment of control buttons or systems to vary the characteristics of stimulation provided by a masturbation device.

### SUMMARY OF THE INVENTION

The present invention provides for a masturbation device that is configured to automatically change and/or adjust its attributes based on how the masturbation device is moved.

According to one aspect of the invention, stimulation characteristics of a masturbation device are dynamically, rapidly, and/or automatically adjusted based on a physical condition of the masturbation device, without requiring a user to engage physical or external buttons, dials, knobs or other control means. The stimulation characteristics disclosed herein include at least one or more of the following characteristics: intensity of movement, duration of movement, frequency of movement, patterns of movement. As used herein, the term physical condition can refer any one or more of the following forms of physical movement: position, rotation, orientation, acceleration, velocity, and/or compression/grip.

The masturbation device disclosed herein includes an electronic system configured to detect changes to the physical condition of the masturbation device or physical manipulation of the masturbation device. For example, the electronic system can detect changes in orientation or location of the masturbation device. As the masturbation device is tilted, thrust, or otherwise moved, the electronic system detects these movements, generates signals related to these movements that are input to a processor, and the processor then signals a movement component, i.e. a motor or other movement mechanism that can, for example, cause vibration, massage, contraction and release, suction, etc., to be driven based on the signals related to the movement of masturbation device.

In one aspect, a masturbation device is disclosed that includes a housing and a motor arranged inside the housing. A processor is connected to the motor, and the processor is configured to provide input signals to the motor. The motor is driven based on the input signals representing stimulation characteristics; and a sensor is connected to the processor and configured to detect physical manipulation of the masturbation device. The sensor provides data to the processor that corresponds to the physical manipulation of the masturbation device. The input signals from the processor to the motor are representative of the data from the sensor such that the stimulation characteristics are based on the physical manipulation.

In one aspect, the physical manipulation of the masturbation device includes at least one of the following: location of the masturbation device, orientation of the masturbation device, compression of the masturbation device, acceleration of the masturbation device, or rotation of the masturbation device.

In one aspect, the input signals from the processor to the motor include at least one of the following: vibration intensity, vibration duration, or vibration pattern.

The housing is sealed and includes a pressure sensor configured to detect internal pressure within the housing. Signals from the pressure sensor are transmitted to the processor, and the processor sends input signals to the motor based on signals from the pressure sensor such that the motor is driven based on the pressure signals.

In another aspect, the sensor is configured to detect pressure applied to a surface of the housing. In one aspect, the device also includes an input module configured to receive user input, which corresponds to customized stimulation characteristics, and the masturbation device vibrates according to the customized stimulation characteristics. The customized stimulation characteristics include at least one of: a vibrational intensity, vibrational duration, vibrational pattern, or vibrational pattern.

In one aspect, the stimulation characteristics are proportional to the physical manipulation.

A control element and an encoder can be included. The encoder is configured to convert an input from the control element into a signal for the processor.

A pressure sensor can be included that extends from the housing. The pressure sensor is configured to detect an applied pressure against an outer area of the masturbation device.

In another aspect, a communication system is provided that includes a first masturbation device and a second masturbation device. The first masturbation device and the second masturbation device are in communication with each other via a network, such that physical manipulation of the first masturbation device corresponds to a vibrational output at the second masturbation device, and physical manipulation of the second masturbation device corresponds to a vibrational output at the first masturbation device.

Additional embodiments, variations and aspects are disclosed herein.

### BRIEF DESCRIPTION OF THE DRAWINGS

The foregoing Summary and the following Detailed Description will be better understood when read in conjunction with the appended drawings, which illustrate a preferred embodiment of the invention. In the drawings:

FIG. 1 illustrates a masturbation device according to an embodiment.

FIG. 2A illustrates another embodiment of the masturbation device.

FIG. 2B illustrates an embodiment of an electronic control system for a masturbation device.

FIGS. 3A, 3B, and 3C illustrate varying degrees of vibration intensity based on orientation of a masturbation device.

FIGS. 4A, 4B, and 4C illustrate varying degrees of vibration intensity based on location of a masturbation device.

FIG. 5 illustrates another embodiment of a masturbation device.

FIG. 6 illustrates an interactive system including two masturbation devices.

### DETAILED DESCRIPTION OF PREFERRED EMBODIMENTS

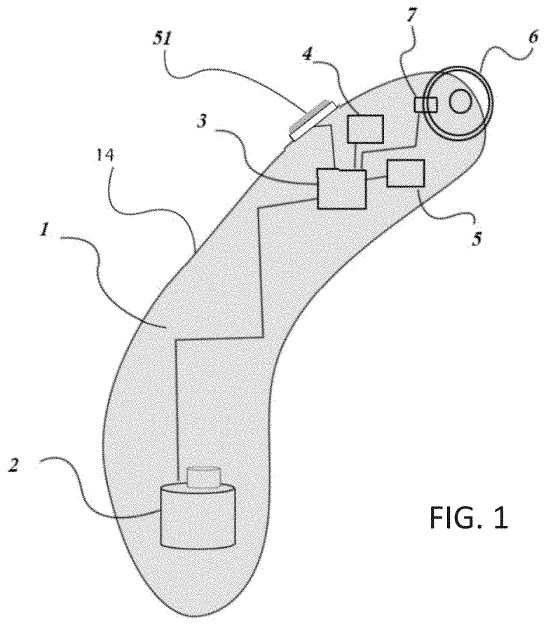

FIG. 1 illustrates the components of a masturbation device 1 according to one embodiment. The masturbation device 1 includes an outer housing 14. In one embodiment, the housing 14 is formed from a flexible material such that the housing 14 can be deformed to change its shape. The housing 14 is sealed from the environment such that any pressure applied to an outer surface of the housing 14 causes a variation of pressure inside of the masturbation device 1. A pressure sensor 4 is arranged within the housing 14. The pressure sensor 4 can be a pressure transducer, and is configured to provide signals to a processor 3 based on a detected internal pressure of the housing 14. Based on the signals from the pressure sensor 4, the processor 3 can adjust characteristics of a motor 2 (i.e. a vibration motor). Signals from the processor 3 to the motor 2 are used to control and drive the motor 2, such that the motor 2 vibrates based on the signals corresponding to varying levels of vibration intensity, frequency, speed, etc.

Another sensor 5 is provided in the masturbation device 1 and in connection with at least the processor 3. The sensor 5 can include an accelerometer, gyroscope, pressure sensor, pressure transducer, or other type of sensor capable of detecting motion, force, orientation, velocity, acceleration, location, or other characteristics.

The masturbation device 1 includes a control element 6 connected to an encoder 7. As used herein, the term encoder refers to a component configured to encode, transmit, or otherwise translate an input, force, or impulse from the control element 6 to another component (i.e. the processor 3) in the masturbation device 1. The encoder 7 is configured to receive an input from the control element 6 and encode, transmit, or translate that input to the processor 3. Therefore, as a user of the masturbation device 1 tilts, moves, rotates, grips or otherwise engages the masturbation device 1, a quality or characteristic of the vibrational output of the motor 2 is adjusted accordingly. In one embodiment, the control element 6 allows a user to manually adjust settings of the masturbation device 1. Stimulation characteristics of the motor 2 of the masturbation device 1 are primarily controlled based on detection of physical manipulation of the masturbation device 1 and not the control element 6.

In one embodiment, the device 1 further includes a button 51 for further manual input. This button 51 can be configured to be used to reset the homing properties of the device 1, i.e. position, orientation or pressure characteristics in which vibrational output is either minimal or maximal. The button 51 can be used to calibrate the device 1, and set a home or base reference point.

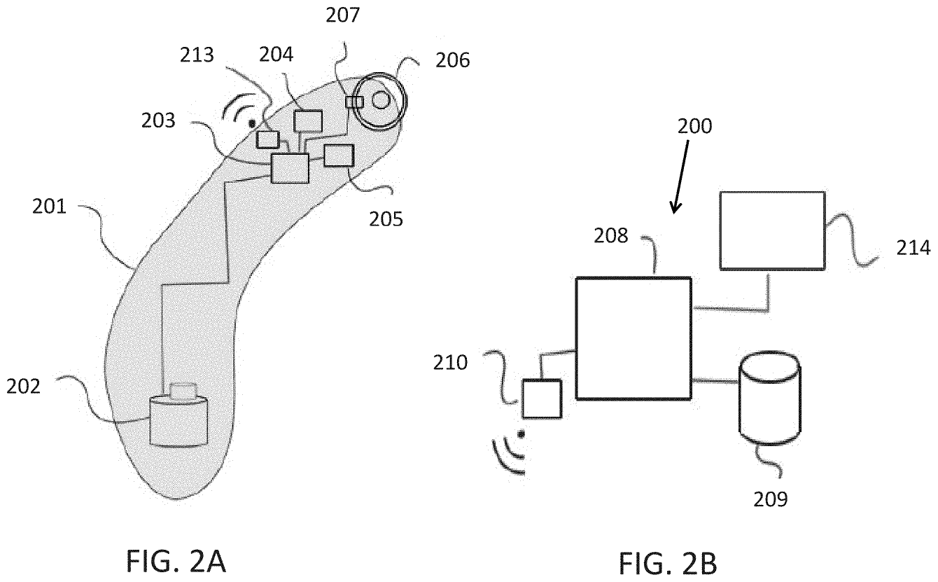

FIG. 2A illustrates another embodiment of the masturbation device 201. As shown in FIG. 2A, the masturbation device 201 includes a motor 202 which receives a signal from the processor 203 such that the motor 202 is driven according to signals from the processor 203. The signals from the processor 203 drive the motor 202 according to a variable characteristic. The masturbation device 201 generally operates according to the same principle of operation as the masturbation device 1 of FIG. 1 except for the specific modifications described herein.

As shown in FIG. 2A, the masturbation device 201 further includes a receiver/transmitter unit 213 which is generally configured to provide communication between the processor 203 and an external computer system 200. The external commuter system 200 can include an external processor 208, external receiver/transmitter unit 210, external memory unit 209, and an input module 214. Based on this configuration, the receiver/transmitter unit 213 is configured to communicate with the corresponding receiver/transmitter unit 210, which is connected to the external processor 208. A computer program or software interface can be implemented on the computer system 200. A user can provide inputs regarding specific vibrational settings, patterns or other characteristics regarding the masturbation device 201 via the input module 214. The input module 214 could be implemented via a keyboard, touchscreen, smartphone, or other electronic input device. Additionally, the computer system 200 can serve as a reference point for the relative position of the masturbation device 201. In other words, as a user moves the masturbation device 201 relative to the computer system 200, specific signals can be generated via the sensor 205. The input module 214 essentially allows a user to create customized stimulation characteristics for the masturbation device 201. The customized stimulation characteristics can include various vibrational patterns, intensities, durations, cycles, etc.

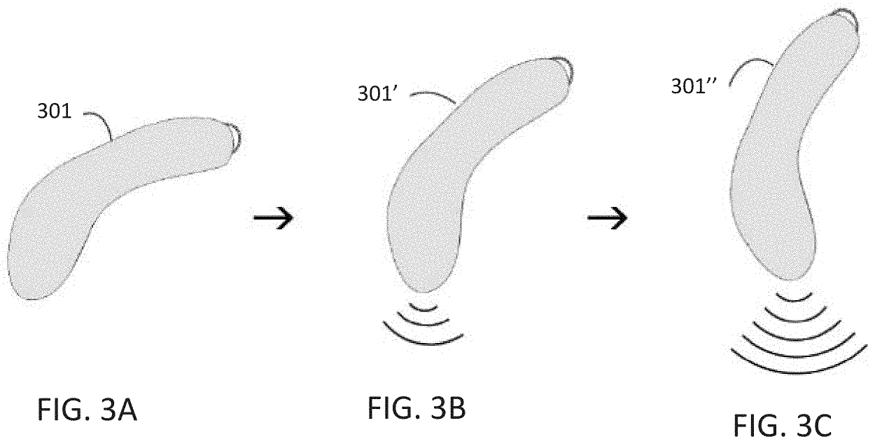

FIGS. 3A-3C illustrate various states for a masturbation device 301, 301′, 301″. In FIGS. 3A-3C, the masturbation device 301, 301′, 301″ exhibits varying vibration intensities. FIG. 3A corresponds to a relatively low intensity or no vibration state, FIG. 3B corresponds to a relatively medium intensity, and FIG. 3C corresponds to a relatively high intensity. A relative tilt or position of the masturbation device 301, 301′, 301″ is altered in FIGS. 3A-3C, which causes the vibrational characteristic to change among FIGS. 3A-3C. The concept disclosed by FIGS. 3A-3C generally shows that a physical manipulation of the masturbation device 301 is modified, i.e. the relative position, which causes a stimulation characteristic, i.e. vibration intensity, of the masturbation device to be modified. One of ordinary skill in the art would understand that this concept can be modified in a variety of ways and is not limited to the relative position of the masturbation device 301 or the vibration intensity (which is controlled by the internal motor 2 previously shown and described at least in FIG. 1). Based on this configuration, a user can easily and intuitively vary an intensity of the vibration by altering the orientation of the masturbation device 301, 301′, 301″.

The computer system 200 disclosed herein allows a user to program various ways in which the physical manipulation of the masturbation device affects the stimulation characteristics of the masturbation device. For example, the stimulation characteristics shown in FIG. 3A can be modified to be the high vibration mode instead of the low intensity or zero vibration mode based on a user's interaction with the computer system 200. The computer system 200 allows a user to program an infinite number of parameters into the processor of the masturbation device such that the masturbation device will behave in a specific manner based on a specific physical manipulation of the masturbation device.

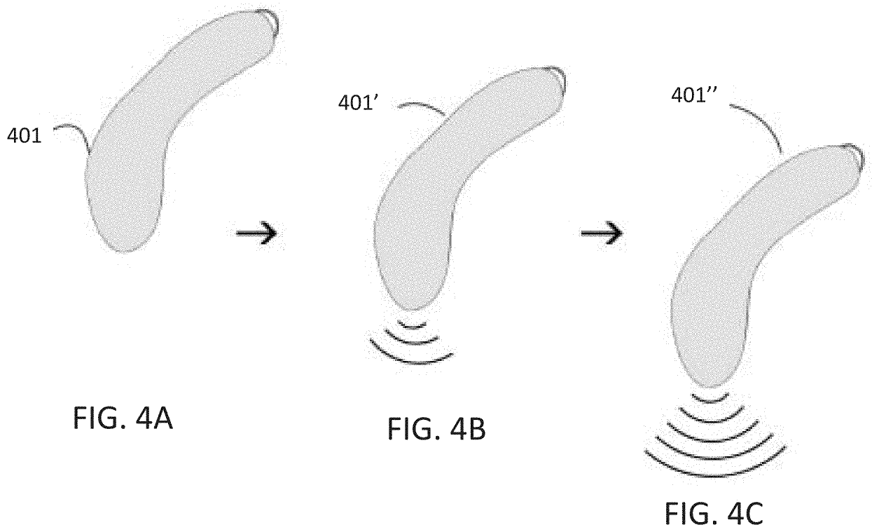

FIGS. 4A-4C illustrate other ways in which physical manipulation of the masturbation device 401, 401′, 401″ can affect stimulation characteristics of the masturbation device. In FIGS. 4A-4C, the masturbation device 401 is moved from an upper position in FIG. 4A, to a medial position in FIG. 4B (shown by masturbation device 401′), to a lower position in FIG. 4C (shown by masturbation device 401″). As shown in FIGS. 4A-4C, the vibration intensity is modified from a low intensity or no vibration mode in FIG. 4A, to a medium vibration intensity in FIG. 4B, to a high vibration intensity in FIG. 4C. The concept generally disclosed in FIGS. 4A-4C illustrates another arrangement in which a physical manipulation or characteristic (i.e. position of the masturbation device) causes a corresponding change in a vibration characteristic of the masturbation device. In one embodiment, the change in the vibration characteristic is proportional to the degree of the physical manipulation. For example, the quicker the pace of displacement or the greater the displacement, then the greater the increase or decrease in vibration intensity. One of ordinary skill in the art would understand based on the present disclosure that the relationship between changes in the physical manipulation does not have to be proportional to the degree of change for the vibration characteristic.

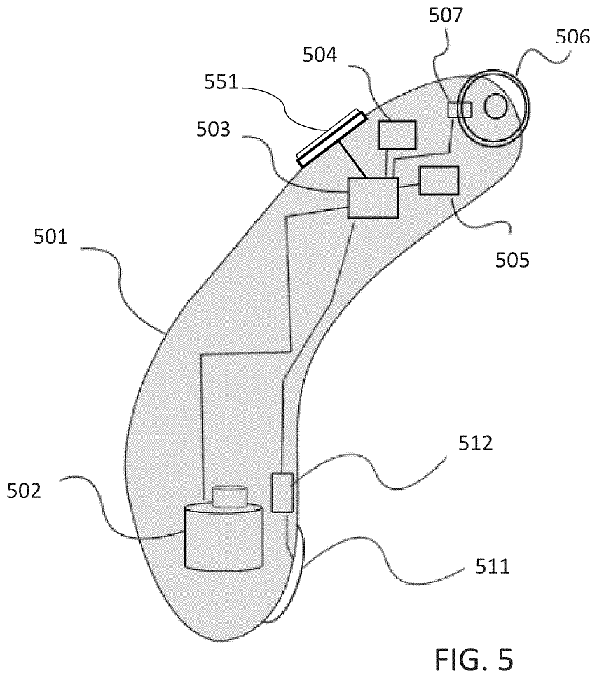

FIG. 5 illustrates another masturbation device 501 that generally includes similar features as the masturbation device of the other embodiments disclosed herein. However, the masturbation device 501 of FIG. 5 includes a pressure sensor 511 connected to a secondary processor 512 that is configured to process data and signals from the pressure sensor 511. The pressure sensor 511 is a compressible button, area, or region, preferably formed on an end of the masturbation device 501, which is configured to detect pressure, i.e. firmness, with which a user is pressing the masturbation device 501 against a surface. A variable signal is generated by the pressure sensor 511 which is then transmitted to the secondary processor 512 and ultimately to the main or core processor 503. One of ordinary skill in the art would understand that the secondary processor 512 can be consolidated or combined with the processor 503.

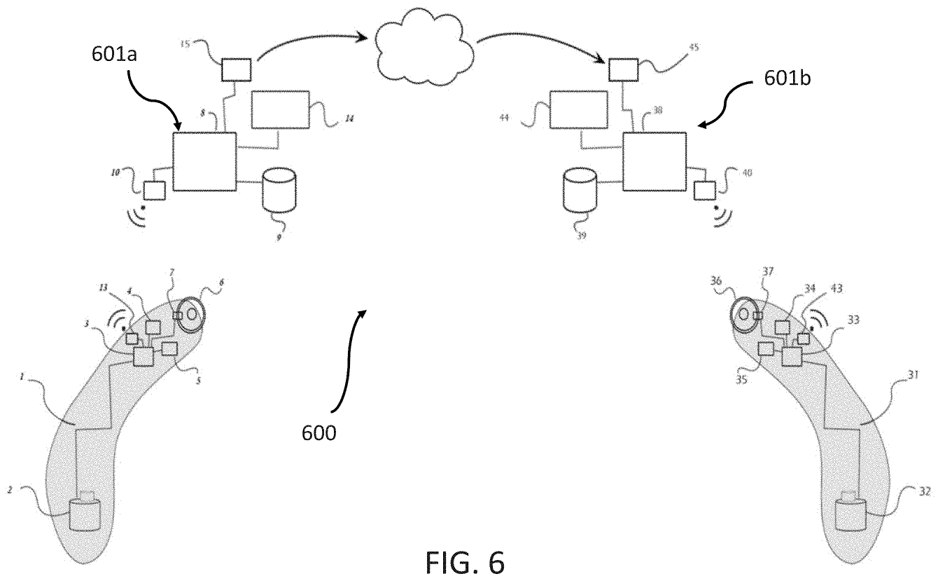

FIG. 6 illustrates an embodiment of an interactive system 600 for connecting a first masturbation device 1 to a second masturbation device 31. The masturbation devices 1, 31 generally include the same features as described herein regarding the other Figures and embodiments. As shown in FIG. 6, a first computer system 601a is provided in communication with the first masturbation device 1. The first computer system 601a includes a first transmitter/receiver unit 10, processor 8, memory storage unit 9, input module 14, and a first network transmitter/receiver unit 15.

A second computer system 601b is in communication with the second masturbation device 31. The second computer system 601b generally includes identical components to the first computer system 601a. The second computer system 601b includes a second network transmitter/receiver unit 45 that is configured to communicate with the first network transmitter/receiver unit 15 via a network, such as the internet.

Data transmitted between the first network transmitter/receiver unit 15 and the second network transmitter/receiver unit 45 can include information regarding orientation, location, internal pressure, and other characteristics regarding the first masturbation device 1 and the second masturbation device 31. Based on the transmission of data between the two masturbation devices 1, 31, a first user and a second user can have dynamic interaction with each other regarding engagement of their respective masturbation devices 1, 31.

Essentially, physical interactions of the first masturbation device 1 are detected by the pressure sensor 4 and sensor 5. Signals from the pressure sensor 4 and the sensor 5 are then transmitted through the first computer system 601a to the second computer system 601b to a user in a remote location using the second masturbation device 31. Based on these signals, the second masturbation device 31 will be driven (i.e. the motor 32 vibrates) based on physical manipulations by the user engaging the first masturbation device 1. Similarly, any physical manipulation of the second masturbation device 31 will result in the first masturbation device 1 experiencing vibrations corresponding to the physical manipulation of the second masturbation device 31. Based on this arrangement, remotely located users engaging in sex play feel the results of movements of their partner which movements relate to the location, orientation and pressure applied to the device used by the partner.

The masturbation devices disclosed herein allow for a new way to modify or adjust the vibration of the masturbation device in an intuitive way for a user. The masturbation devices allow a user to easily and intuitively vary the degree of vibration by simply rotating, moving, gripping, tilting, or otherwise physically engaging the masturbation device. Adjustment of the stimulation characteristics is carried out via the sensor without any requirement that the user engages a control button, dial, or switch. The user can continue gripping the masturbation device as a user would during ordinary use of a masturbation device without having to move their hands or fingers to engage buttons on the masturbation device.

It is also appreciated that the present embodiments could be used in the context of webcam models and websites. For example, it is contemplated that the a masturbation device according to the present invention can be configured to operate in connection with a website featuring webcam models that utilize such a masturbation device. Viewers or users of the webcam website can log on and view such a masturbation device used by a webcam model.

One of ordinary skill in the art would understand that the concept and devices disclosed herein can be adapted for both female and male users. Additionally, the following documents are incorporated by reference: U.S. Pat. Nos. 8,255,299; 10,143,618; 10,195,105. Any one or more of the features from these documents can be incorporated into the masturbation device disclosed herein.

Having thus described the present embodiments in detail, it is to be appreciated and will be apparent to those skilled in the art that many physical changes, only a few of which are exemplified in the detailed description of the embodiments, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the embodiments being indicated by the appended claims rather than by the foregoing description, and all alternate embodiments and changes to this embodiment which come within the meaning and range of equivalency of said claims are therefore to be embraced therein.

What is claimed is:

1. A masturbation device comprising:
a housing;
a motor arranged inside the housing;
a processor connected to the motor, the processor configured to provide input signals to the motor, and the motor being driven based on the input signals representing stimulation characteristics; and
a sensor connected to the processor and configured to detect physical manipulation of the masturbation device, the sensor providing data to the processor that corresponds to the physical manipulation of the masturbation device;
wherein the input signals from the processor to the motor are representative of the data from the sensor such that the stimulation characteristics are based on the physical manipulation.

2. The masturbation device of claim 1, wherein the physical manipulation of the masturbation device includes at least one of the following:
location of the masturbation device, orientation of the masturbation device, compression of the masturbation device, acceleration of the masturbation device, or rotation of the masturbation device.

3. The masturbation device of claim 1, wherein the input signals from the processor to the motor include at least one of the following:
vibration intensity, vibration duration, or vibration pattern.

4. The masturbation device of claim 1, wherein the housing has an elongated shape.

5. The masturbation device of claim 1, wherein the housing is sealed and includes a pressure sensor configured to detect internal pressure within the housing,
signals from the pressure sensor are transmitted to the processor, and
the processor sends input signals to the motor based on signals from the pressure sensor such that the motor is driven corresponding to the pressure signals.

6. The masturbation device of claim 1, wherein the motor is a vibration motor, and the input signals are based on an orientation or a location of the masturbation device.

7. The masturbation device of claim 1, wherein the sensor is configured to detect pressure applied to a surface of the housing.

8. The masturbation device of claim 1, further comprising an input module configured to receive user input, wherein the user input includes customized stimulation characteristics, and the masturbation device vibrates according to the customized stimulation characteristics.

9. The masturbation device of claim 8, wherein the customized stimulation characteristics include at least one of: a vibrational intensity, vibrational duration, vibrational pattern, or vibrational pattern.

10. The masturbation device of claim 1, wherein the stimulation characteristics are proportional to the physical manipulation.

11. The masturbation device of claim 1, further comprising a control element and an encoder, wherein the encoder is configured to convert an input from the control element into a signal for the processor.

12. The masturbation device of claim 1, further comprising a pressure sensor extending from the housing, the pressure sensor configured to detect an applied pressure against an outer area of the masturbation device.

13. The masturbation device of claim 1, further comprising a homing button configured to reset orientation, position and touch characteristics in which vibrational outputs of the motor are minimal or maximal.

14. A communication system including the masturbation device of claim 1, and further comprising a secondary masturbation device, wherein the masturbation device and the secondary masturbation device are in communication with each other via a network, such that physical manipulation of the masturbation device corresponds to a vibrational output at the secondary masturbation device, and physical manipulation of the secondary masturbation device corresponds to a vibrational output at the masturbation device.

15. A masturbation device comprising:
a housing;
a vibration motor arranged inside the housing, the vibration motor configured to vibrate according to at least one vibrational characteristic;
a processor connected to the motor, the processor configured to send input signals to the motor such that the motor is driven based on the input signals; and
a sensor connected to the processor and configured to detect physical manipulation of the masturbation device, the processor being configured to receive data from the sensor corresponding to the physical manipulation of the masturbation device,
wherein the input signals from the processor to the motor are representative of the data from the sensor, the vibration motor is driven according to the at least one vibrational characteristic, and the at least one vibrational characteristic varies based on the physical manipulation of the masturbation device.

16. A masturbation device comprising:
a housing including a vibrational motor and a sensor, wherein the vibrational motor is adjustably driven based on a signal from the sensor that corresponds to physical manipulation of the masturbation device.
